(19) United States
(12) Patent Application Publication
(10) Pub. No.: US 2025/0060815 A1
(43) Pub. Date: Feb. 20, 2025

(54) ADAPTIVE FOVEATED CODING FOR SPLIT RENDERING

(71) Applicant: QUALCOMM Incorporated, San Diego, CA (US)

(72) Inventors: Imed BOUAZIZI, Celina, TX (US); Thomas STOCKHAMMER, Bergen (DE)

(21) Appl. No.: 18/745,912

(22) Filed: Jun. 17, 2024

Related U.S. Application Data
(60) Provisional application No. 63/519,826, filed on Aug. 15, 2023.

(51) Int. Cl. G06F 3/01; G06F 3/14

(52) U.S. Cl. CPC G06F 3/013; G06F 3/14; G06F 3/012

(57) ABSTRACT

This disclosure provides systems, devices, apparatus, and methods, including computer programs encoded on storage media, for adaptive foveated coding for split rendering. A processor may receive, over a network, a first indication of a gaze of a user on a display panel of a device. The processor may compute, based on the first indication of the gaze of the user, an importance map for an encoding of a frame. The processor may encode a set of regions of the frame based on the importance map. The processor may output a second indication of the encoded set of regions of the frame.

### CROSS REFERENCE TO RELATED APPLICATION(S)

This application claims the benefit of and priority to U.S. Provisional Application Ser. No. 63/519,826, entitled “ADAPTIVE FOVEATED CODING FOR SPLIT RENDERING” and filed on Aug. 15, 2023, which is expressly incorporated by reference herein in its entirety.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for split rendering may encode different regions of a frame at the same bitrate. There is a need for improved split rendering techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: receive, over a network, a first indication of a gaze of a user on a display panel of a device; compute, based on the first indication of the gaze of the user, an importance map for an encoding of a frame; encode a set of regions of the frame based on the importance map; and output a second indication of the encoded set of regions of the frame.

In an aspect of the disclosure, a method, a computer-readable medium, and an apparatus for graphics processing are provided. The apparatus includes a memory; and a processor coupled to the memory and, based on information stored in the memory, the processor is configured to: transmit, over a network, a first indication of a gaze of a user on a display panel of a device; receive, over the network and based on the first indication of the gaze of the user, a bitstream for a frame, where the bitstream includes a set of bitrates for a set of regions of the frame; and output an indication of the received bitstream.

In some aspects, the techniques described herein relate to a method of graphics processing, including: receiving, over a network, a first indication of a gaze of a user on a display panel of a device; computing, based on the first indication of the gaze of the user, an importance map for an encoding of a frame; encoding a set of regions of the frame based on the importance map; and outputting a second indication of the encoded set of regions of the frame.

In some aspects, the techniques described herein relate to a method, where encoding the set of regions of the frame includes adjusting a bitrate for at least one region in the set of regions of the frame based on the importance map.

In some aspects, the techniques described herein relate to a method, where adjusting the bitrate for the at least one region in the set of regions includes setting a first bitrate for a first region in the at least one region and setting a second bitrate for a second region in the at least one region, where the first bitrate is different from the second bitrate.

In some aspects, the techniques described herein relate to a method, where outputting the second indication of the encoded set of regions of the frame includes transmitting, for the device, a bitstream that includes the adjusted bitrate for the at least one region in the set of regions of the frame.

In some aspects, the techniques described herein relate to a method, where the first indication of the gaze of the user includes at least one of a set of predicted eye gaze poses of the user, a set of time intervals for which the set of predicted eye gaze poses is valid, or a set of confidence values for the set of predicted eye gaze poses.

In some aspects, the techniques described herein relate to a method, where computing the importance map further includes: normalizing the set of confidence values based on the set of predicted eye gaze poses, where computing the importance map includes computing the importance map further based on the normalized set of confidence values.

In some aspects, the techniques described herein relate to a method, where computing the importance map further includes: sorting the set of predicted eye gaze poses based on the normalized set of confidence values.

In some aspects, the techniques described herein relate to a method, where computing the importance map further includes: identifying, based on (1) the sorted set of predicted eye gaze poses and (2) the normalized set of confidence values, the set of regions of the frame; and assigning, based on the normalized set of confidence values, a set of importance values to the set of regions of the frame.

In some aspects, the techniques described herein relate to a method, where computing the importance map further includes: determining that a first region and a second region in the set of regions are within a threshold distance of one another; merging, based on the determination, the first region and the second region into a single region; and assigning, based on a first importance value of the first region and a second importance value of the second region, a single confidence value to the single region.

In some aspects, the techniques described herein relate to a method, where each of the set of regions is associated with one or more coding tree units (CTUs).

In some aspects, the techniques described herein relate to a method, where identifying the set of regions of the frame includes identifying a set of importance regions and a set of non-importance regions, and where assigning the set of importance values includes assigning a minimum importance value to each of the set of non-importance regions.

In some aspects, the techniques described herein relate to a method, further including: obtaining a third indication including at least one of prior gaze information for the user of the device, animation elements associated with the frame, interactivity elements associated with the frame, or region of interest (ROI) information associated with the frame, where computing the importance map includes computing the importance map further based on the third indication.

In some aspects, the techniques described herein relate to a method, where the frame is associated with extended reality (XR) content of the device, and where the device is one of a wearable display device, a headset, or a head-mounted display (HMD).

In some aspects, the techniques described herein relate to a method, where receiving the first indication of the gaze of the user includes receiving, via a wireless connection, the first indication of the gaze.

In some aspects, the techniques described herein relate to a method, further including: performing a negotiation with the device to enable eye tracking and transmission, where receiving the first indication of the gaze includes receiving the first indication of the gaze subsequent to the performed negotiation.

In some aspects, the techniques described herein relate to a method of graphics processing, including: transmitting, over a network, a first indication of a gaze of a user on a display panel of a device; receiving, over the network and based on the first indication of the gaze of the user, a bitstream for a frame, where the bitstream includes a set of bitrates for a set of regions of the frame; and outputting an indication of the received bitstream.

In some aspects, the techniques described herein relate to a method, further including: performing a negotiation with a server to enable eye tracking and transmission, where transmitting the first indication of the gaze includes transmitting the first indication of the gaze subsequent to the performed negotiation.

In some aspects, the techniques described herein relate to a method, where the bitstream includes a first bitrate for a first region in the set of regions and a second bitrate for a second region in the set of regions, where the first bitrate is different from the second bitrate.

In some aspects, the techniques described herein relate to a method, where the first indication of the gaze of the user includes at least one of a set of predicted eye gaze poses of the user, a set of time intervals for which the set of predicted eye gaze poses is valid, or a set of confidence values for the set of predicted eye gaze poses.

In some aspects, the techniques described herein relate to a method, further including: generating, via a camera of the device, the set of predicted eye gaze poses of the user.

In some aspects, the techniques described herein relate to a method, further including: obtaining, via an extended reality (XR) runtime, the set of confidence values for the set of predicted eye gaze poses.

In some aspects, the techniques described herein relate to a method, further including: estimating, based on confidence criteria, the set of confidence values for the set of predicted eye gaze poses.

In some aspects, the techniques described herein relate to a method, where the confidence criteria include at least one of a time difference between a first time instance corresponding to a transmission of the first indication and a second time instance corresponding to a display time for the frame, a set of head poses of the user, or an estimated velocity of a head of the user.

In some aspects, the techniques described herein relate to a method, where the bitstream is encoded, where outputting the indication of the received bitstream includes: decoding the bitstream to produce the frame; and transmitting the frame for display on the display panel.

In some aspects, the techniques described herein relate to a method, where transmitting the first indication of the gaze of the user includes transmitting, via a wireless connection, the first indication of the gaze.

In some aspects, the techniques described herein relate to a method, where the frame is associated with extended reality (XR) content of the device, and where the device is one of a wearable display device, a headset, or a head-mounted display (HMD).

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating example aspects of foveated rendering in accordance with one or more techniques of this disclosure.

FIG. 5 is a diagram illustrating an example process for foveated split rendering in accordance with one or more techniques of this disclosure.

FIG. 6 is a diagram illustrating example regions of interest for a frame in accordance with one or more techniques of this disclosure.

FIG. 7 is a diagram illustrating example regions of interest for a frame in accordance with one or more techniques of this disclosure.

FIG. 8 is a diagram illustrating example aspects pertaining to an eye gaze prediction format in accordance with one or more techniques of this disclosure.

FIG. 9 is a connection flow diagram illustrating an example of a client device configured to communicate with a server device, in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Split rendering may refer to a paradigm whereby performance of rendering tasks for content (e.g., extended reality (XR) content) are split between a first device (e.g., a server, a companion device, a remote device, etc.) and a second device (e.g., a wearable display device, such as a head mounted display (HMD)) that are in wired or wireless communication with one another. For example, the first device may render a frame, and the second device may output a version of the frame to a display. The second device may perform reprojection on the frame received from the first device before outputting the version of the frame to the display. In general, the first device may have relatively greater computational capabilities than computational capabilities of the second device. For instance, the second device may have limited battery power and/or processing capabilities. Split rendering may help to conserve battery power and/or computational resources of the second device. In an example, the second device may be an HMD that includes high resolution display(s) (e.g., 4K display(s)). As a result, a server may transmit rendered content (i.e., a frame) to the HMD in a bitstream that has a high bit rate. However, not all regions of the rendered content may be equally important to a user.

Various technologies pertaining to adaptive foveated coding for split rendering are described herein. In an example, an apparatus (e.g., a server) may receive, over a network, a first indication of a gaze of a user on a display panel of a device. The apparatus (e.g., a server) computes, based on the first indication of the gaze of the user, an importance map for an encoding of a frame. The computed importance map may associate regions of the frame with an importance metric, such as a confidence value or an eye gaze focus. The apparatus (e.g., a server) may encode a set of regions of the frame based on the computed importance map. For example, the apparatus may encode the bitrate for each region of a computed importance map based on the importance metric associated with the corresponding region. The apparatus (e.g., a server) may output a second indication of the encoded set of regions of the frame. Vis-à-vis encoding the set of regions of the frame based on the computed importance map, the apparatus may reduce a bit rate at which the frame is transmitted while still preserving important details in the frame. Thus, the above-described technologies may be associated with a reduction in network traffic and/or a reduction in computational burdens placed on the apparatus (e.g., a server). The server may be a split rendering server (SRS) configured to render frames for a client device, such as a wearable display device. The rendered frames may be transmitted to the client device using wired or wireless transmission means. In another example, an apparatus (e.g., a wearable display device) may transmit, over a network, a first indication of a gaze of a user on a display panel of a device. The apparatus may have a sensor that tracks a gaze of the user over time. The first indication of the gaze may include a set of predicted gaze poses of the user and associated confidence values for each of the set of predicted gaze poses. The first indication of the gaze may include a set of historical gaze poses of the user and corresponding time intervals. The apparatus (e.g., a wearable display device) may receive, over the network and based on the first indication of the gaze of the user, a bitstream for a frame, where the bitstream includes a set of bitrates for a set of regions of the frame. The corresponding bitrate for at least two of the set of regions may differ from one another based on the transmitted first indication of the gaze of the user. The apparatus (e.g., a wearable display device) may output an indication of the received bitstream. Vis-à-vis receiving the bitstream that includes a set of bitrates for a set of regions of the frame, the above-described technologies may be associated with a reduction in network traffic and/or a reduction in computational burdens placed on the apparatus (e.g., a wearable display device). Such systems may combine foveated and split rendering. A wearable display device may transmit eye gaze pose information that may be used by a server to calculate eye gaze pose predictions with a score and a confidence level. In another aspect, a wearable display device may transmit eye gaze pose predictions to a server with a score and confidence interval. The server may generate content region of interest (ROI) maps based on the received/calculated eye gaze pose prediction information. The server may use the ROI maps and foveate maps to adapt the encoding of the next video frame (e.g., focus more resources on high confidence level ROI areas based on foveation constraints. In some aspects, the server may create a 2D map that matches coding tree units (CTUs) and normalize and sort the confidence values for gaze pose predictions. For each prediction, the server may determine a radius of the region based on confidence (higher confidence->larger radius). In some aspects, the server may scale the importance values (e.g., confidence values) based on the fraction of the CTUs covered by an importance region to the total number of CTUs and may assign minimum importance values to the remaining areas. In some aspects, if a server does not receive confidence values, the server may estimate confidence values based on a time delta between the current time and time where the prediction applies, based on a distance of the predicated eye gaze pose to the eye gaze pose at current time, and/or based on an estimated velocity for the location. Such calculations may be weighted. In some aspects, a server may use ROI information, prior eye gaze information, and/or animation/interactivity of scene for mapping.

In some aspects, where use of eye gaze tracking is activated, a server (e.g., an SRS) may use confidence information to perform gaze-based optimizations, such as foveated rendering and/or foveated video encoding. In foveated rendering, the rendering engine may render areas of a picture with a higher quality than other areas based on the user's current, or predicted gaze. Areas associated with a higher confidence level may be associated with a higher quality than areas associated with a lower confidence level. In foveated video encoding, areas of a picture associated with a higher confidence value may be encoded with a higher signal to noise ratio (SNR) quality than areas associated with a lower confidence value. With gaze predictions, a server may generate an importance map for a picture based on the confidence values associated with gaze predictions. The server may also use other information to produce the importance map, such as content regions of interest (ROI), type of the experience being rendered (e.g., game genre), and device type of the client. In some aspects, a confidence value less than or equal to a threshold may be associated with an estimation that is not adequate. In response, a server may re-estimate the confidence values based on the latest retrieved gaze prediction data prior to rendering and encoding. In some aspects, the server may output an importance map for foveated encoding to an encoder to properly allocate bits for the encoding of a picture. For foveated rendering, a server or a rendering engine of the server may also generate an importance map to use to differentially allocate rendering resources for a frame. When both foveated rendering and foveated encoding is used, an importance map used for rendering may take into consideration an importance map used for encoding, and vice-versa.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

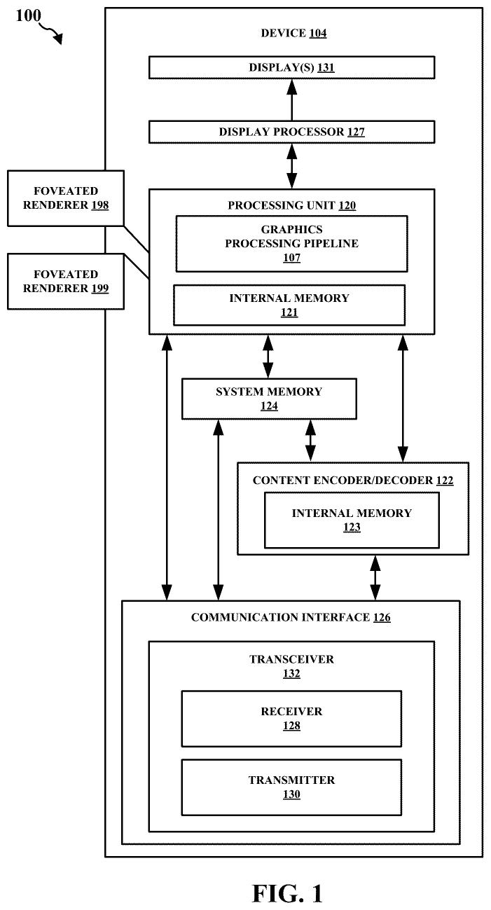

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). The transceiver 132 may include a set of antennas. The transceiver 132 may be functionally coupled to the processing unit 120. Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a foveated renderer 198 configured to receive, over a network, a first indication of a gaze of a user on a display panel of a device; compute, based on the first indication of the gaze of the user, an importance map for an encoding of a frame; encode a set of regions of the frame based on the importance map; and output a second indication of the encoded set of regions of the frame. In certain aspects, the processing unit 120 may include a foveated renderer 199 configured to transmit, over a network, a first indication of a gaze of a user on a display panel of a device; receive, over the network and based on the first indication of the gaze of the user, a bitstream for a frame, where the bitstream includes a set of bitrates for a set of regions of the frame; and output an indication of the received bitstream. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may change the corresponding context. Additionally, the workload that corresponds to the mode or state may follow the changing mode or state.

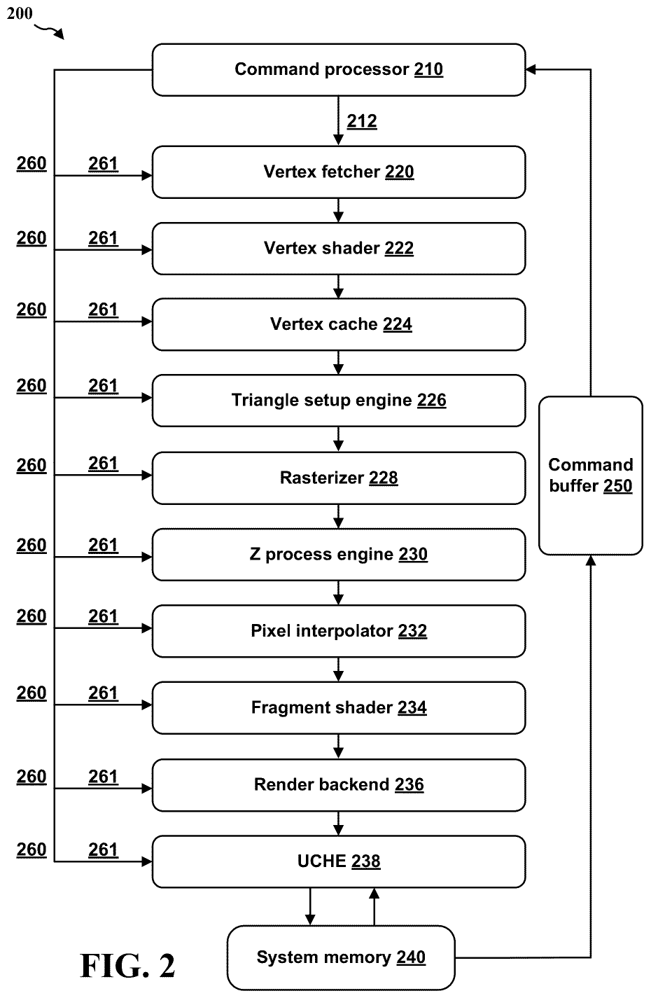

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

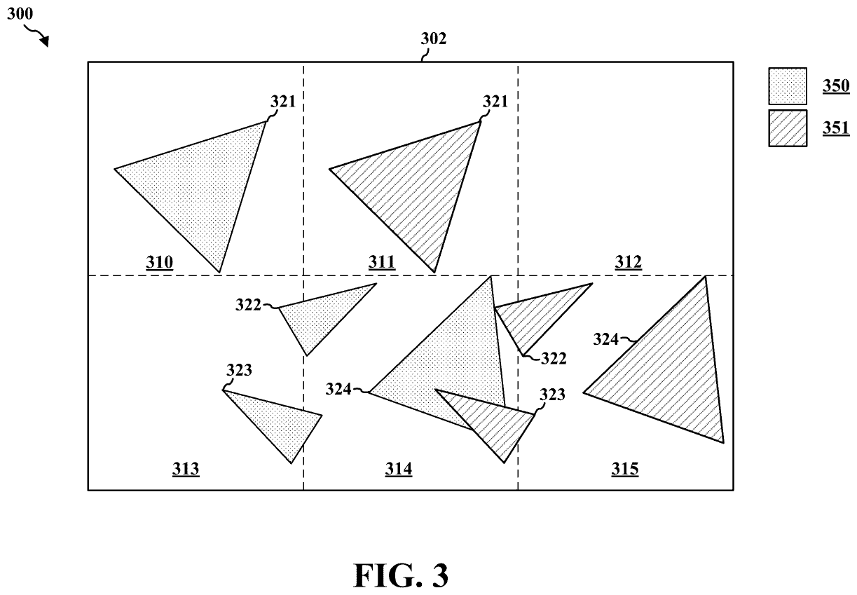

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

Split rendering may be used to perform heavy graphics work at an edge/cloud/server. A head mounted display (HMD) may have limited battery power and/or limited processing capabilities. Delegating some (or all) rendering tasks to the edge/cloud/server may preserve battery power and processing resources of the HMD.

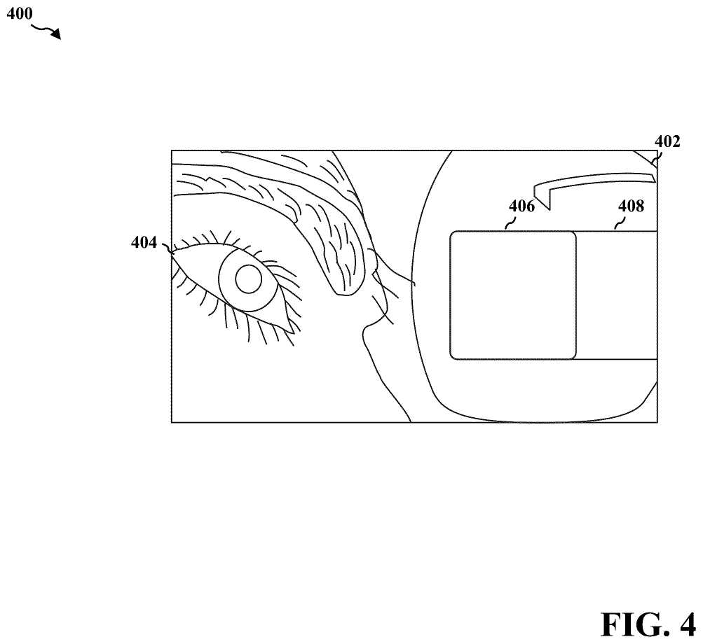

FIG. 4 is a diagram 400 illustrating example aspects of foveated rendering in accordance with one or more techniques of this disclosure. For an HMD with high quality target displays (e.g., dual 4K displays), a display resolution and a resulting bit rate for data transmitted between the HMD and a server may be high. A viewer using the HMD may be focused on certain areas of a viewport associated with the HMD that is of interest to them. For example, a user may focus an eye 404 on a first portion 406 of a display 402, and may not focus the eye 404 on a second portion 408 of the display 402. An eye tracker of the HMD may track where the user focuses the eye 404. The eye tracker may include, for example, a camera of the HMD. The human visual system may tend to blur edge areas of a frame that a user is not focused on. In other words, the eye 404 of the user may have a higher capability to focus on the first portion 406 of the display 402 and may have a lower capability to focus on the second portion 408 of the display 402. Foveated rendering may rely on gaze tracking to optimize a rendering workload to areas on the display 402 that the user is currently focused on. Foveated rendering may save processing power by reducing quality of out-of-focus peripheral areas of a frame. In other words, foveated rendering may increase the quality of the first portion 406 of the display 402 and/or may decrease the quality of the second portion 408 of the display 402 when the eye is focused on the first portion 406 of the display 402. The technologies described herein pertain to extending foveated rendering into split rendering. In the technologies described herein, rendering may occur remotely, for example 20-50 milliseconds after a gaze pose is determined.

In one aspect, a method and an apparatus to perform adaptive predictive foveated coding is described herein. Eye gaze pose predictions may be sent to a server with a score/confidence interval. Content region of interest (ROI) maps (i.e., importance maps) may be generated by an application on the server (i.e., a split rendering server). The server may use ROI maps and foveation maps to adapt an encoding of video frames (e.g., next video frames).

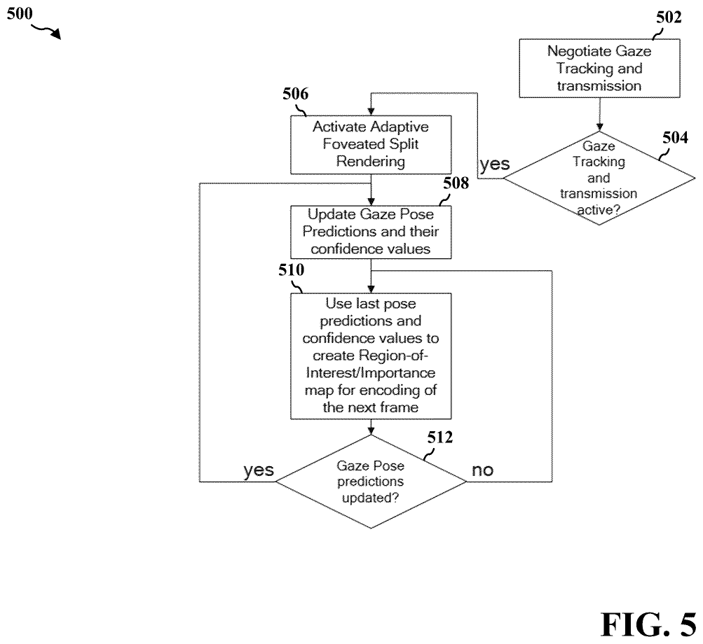

FIG. 5 is a diagram 500 illustrating an example process for foveated split rendering in accordance with one or more techniques of this disclosure.

At 502, a server device (e.g., an SRS) and a client device (e.g., a wearable display device) may negotiate gaze tracking and transmission of such gaze tracking information from the client device to the server device. For example, the client device may transmit an indication of a gaze of a user on a display panel of the device to the server. The indication may include a set of predicted eye gaze poses for the user. The indication may include a confidence value associated with each of the set of predicted eye gaze poses for the user. In some aspects, the indication may include a set of historical eye gaze poses and a time stamp associated with each of the set of predicted eye gaze poses. In some aspects, the indication may include a set of predicted eye gaze poses of the user, a set of time intervals for which the set of predicted eye gaze poses is valid (e.g., when the eye gaze is predicted to look in that direction), and/or a set of corresponding confidence values associated with the set of predicted eye gaze poses. The server device may calculate a set of predicted eye gaze poses for the user and a confidence value for each of the set of predicted eye gaze poses.

At 504, the server device may determine whether the client device is actively transmitting gaze tracking information to the server device. If the client device is not actively transmitting gaze tracking information to the server device, the server device may wait until the client device is actively transmitting gaze tracking information to the server device. If the client device is actively transmitting gaze tracking information to the server device, at 506, the server device may activate adaptive foveated split rendering. As the server device receives gaze tracking information from the client device, the server device may update gaze pose predictions and their confidence values based on the received indication of gaze tracking information from the client device.

At 508, the server device may update gaze pose predictions and their confidence values based on each received indication of the gaze of the user on a display panel of the client device. At 510, the server device may use last pose predictions and confidence values to generate region-of-interest (ROI) areas for the display based on the predicted gaze information. The server device may use last pose predictions and confidence values to generate an importance map for encoding of the next frame. The importance map may have ROI areas for a display and associated confidence values for each ROI. At 512, the server device may wait for an update to the gaze pose predictions. If an update is received from the client device, at 508, the server device may update gaze pose predictions and their confidence values based on the received update. If an update is not received from the client device, at 510 the server device may use the last pose predictions and confidence values for encoding the next frame for the client device.

In one aspect, an importance map (i.e., an ROI map) may be created using the following procedure. A 2D map may be created that matches coding tree unit (CTU) subdivisions of a frame (i.e., a picture). A server may normalize confidence values for all gaze pose predictions. The server may sort the gaze pose predictions by descending order according for their normalized confidence values. For each gaze pose prediction, the server may (1) determine a radius of an importance region, where higher confidence values may correspond to a larger radius and (2) determine an importance value to be assigned to a region based on a magnitude of a normalized confidence region. The server may merge importance regions that are too close to one another. For example, the server may determine regions that are within a threshold distance of one another, and may merge the regions based on their confidence values. For example, the server may assign an average of the confidence values to the new region, or may assign a weighted combination of the confidence values to the new region, where the weight is based on the size of the original region. The server may scale the importance values based on a fraction of CTU subdivisions covered by an importance region to a total number of CTU subdivisions. Alternatively, the server may sum areas of all importance regions to the area of the full frame (i.e., the full picture). The server may assign minimum importance values to remaining areas/CTU subdivisions of the frame (i.e., the picture).

In one aspect, the server may use the importance map/ROI map. For instance, the server may adjust a rate control algorithm based on the importance map/ROI map. Higher importance area in the frame may be assigned with a higher number of bits.

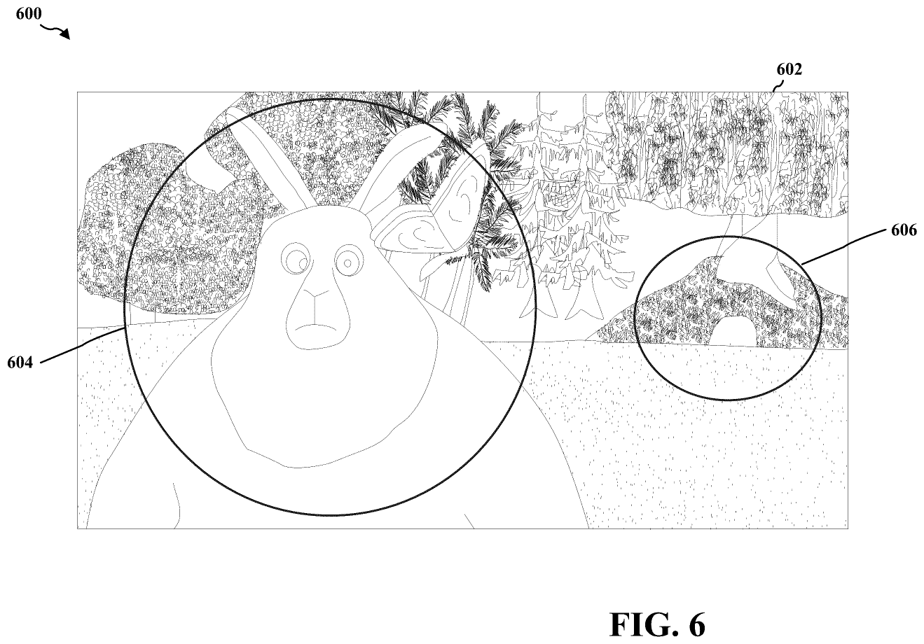

FIG. 6 is a diagram 600 illustrating example regions of interest (ROI) for a frame in accordance with one or more techniques of this disclosure. A frame 602 may be associated with a plurality of ROIs generated based on a set of predicted eye gaze poses and associated confidence values. The greater the confidence value, the greater the ROI. For example, the ROI 604 may be associated with a greater confidence value than the ROI 606. The frame 602 with the ROI 604 and the ROI 606 may be generated as an importance map based on a set of predicted eye gaze poses and associated confidence values. In some aspects, a server device may be configured to render an area of the frame 602 that is designated an ROI with a higher pixel per degree (PPD) than an area that is not designated an ROI. For example, the server device may determine that regions that are designated an ROI may be importance regions, and regions that are not designated an ROI may be non-importance regions. With respect to frame 602, the ROI 604 and the ROI 606 may be designated importance regions, and all other regions of frame 602 may be designated non-importance regions. In some aspects, a server device may allocate a higher amount of rendering resources to an area that is designated an ROI than an area that is not designated an ROI.

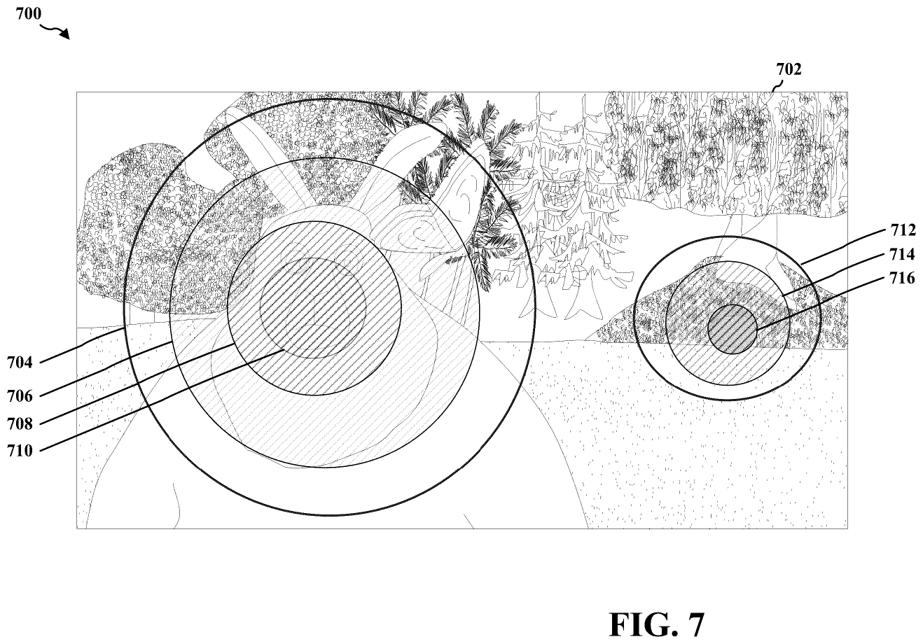

FIG. 7 is a diagram 700 illustrating example regions of interest for a frame 702 in accordance with one or more techniques of this disclosure. A frame 702 may be associated with a plurality of ROIs generated based on a set of predicted eye gaze poses and associated confidence values. The greater the confidence value, the greater the ROI. An ROI with a darker shade may be associated with a higher confidence value than an ROI with a lighter shade. For example, the ROI 704 may be associated with a first confidence value, the ROI 706 may be associated with a second confidence value greater than the first confidence value, the ROI 708 may be associated with a third confidence value greater than the second confidence value, and the ROI 710 may be associated with a fourth confidence value greater than the third confidence value. Similarly, the ROI 712 may be associated with a fifth confidence value, the ROI 714 may be associated with a sixth confidence value greater than the fifth confidence value, and the ROI 716 may be associated with a seventh confidence value greater than the sixth confidence value. An area of the frame 702 without an ROI may be assigned a base confidence value. The frame 702 with the ROI 704, the ROI 706, the ROI 708, the ROI 710, the ROI 712, the ROI 714, and the ROI 716 may be generated as an importance map based on a set of predicted eye gaze poses and associated confidence values. In some aspects, a server device may be configured to render an area of the frame 702 with a PPD value that linearly scales with the corresponding confidence value. For example, the ROI 710 may be rendered with a higher PPD value than the ROI 704.

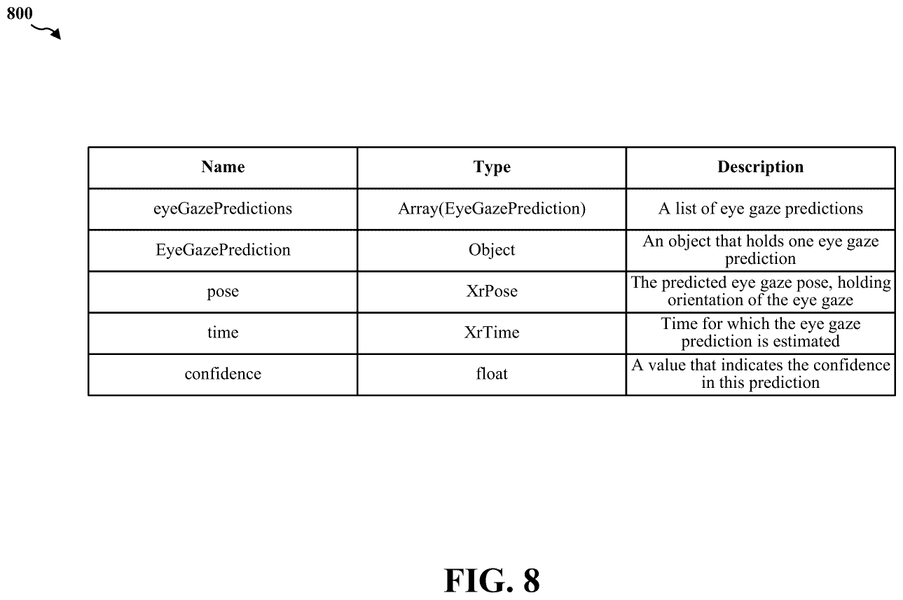

FIG. 8 is a diagram 800 illustrating example aspects pertaining to an eye gaze prediction format in accordance with one or more techniques of this disclosure. The eye gaze prediction format depicted in the diagram 800 may be JavaScript Object Notation (JSON) based. The eye gaze predictions may be sent to a server using a data channel when the eye gaze predictions are available.

In one aspect, extended reality (XR) runtimes may provide a confidence value for a prediction. For instance, an OpenXR function “xrGetEyeGazesFB” may return a confidence value. If no confidence value is provided, a confidence value may be estimated using one or more of: (1) a time delta between a current time and a time for which a prediction applies, (2) a distance of a pose to an eye pose at a current time, and/or (3) an estimated velocity for a location.

In one aspect, the importance map/ROI map may take into account information that is provided by an application or content provider. For example, the information may include region of interest information, a prior history of eye gaze tracking information for content that is the same as or similar to content in a current frame, and/or similar to animation and interactivity elements in a three-dimensional (3D) scene.

The technologies described herein may use an adaptive foveated encoding method and an apparatus for split rendering. The technologies described herein may use multiple prediction with confidence levels to adjust a bit rate allocation based on a created importance map/ROI map.

In another aspect, Table 1 below may be used to indicate eye pose information of a user.

TABLE 1
pose format

| Name | Type | Cardinality | Description |
|---|---|---|---|
| poseInfo | Object | 1 . . . n | An array of pose information |
| | | | objects, each corresponding |
| | | | to a target display time and |
| | | | extended reality (XR) space. |
| poseTime | number | 1 . . . 1 | The time for which the |
| | | | current poses are predicted. |
| | | | This time may be expressed in |
| | | | XR system time clock. |
| xrSpaceId | number | 0 . . . 1 | An identifier for the XR space |
| | | | in which the poses are expressed. |
| poses | Object | 1 . . . n | An array that provides a list |
| | | | of the poses. |
| | | | For view poses, the first pose |
| | | | corresponds to the left view and |
| | | | the second to the right view. |
| trackableSpaceId | number | 0 . . . 1 | A unique identifier of the |
| | | | XR space of the trackable |
| | | | that was agreed upon during |
| | | | session setup. The pose |
| | | | corresponds to the origin |
| | | | of that trackableSpaceId |
| | | | expressed in the XR space |
| | | | identified by xrSpaceId. |
| | | | This is applicable for |
| | | | trackable pose. |
| orientation | Object | 1 . . . 1 | Represents the orientation |
| | | | of the pose as a quaternion |
| | | | based on the reference XR |
| | | | space identified by xrSpaceId. |
| x | number | 1 . . . 1 | Provides the x coordinate |
| | | | of the quaternion. |
| y | number | 1 . . . 1 | Provides the y coordinate |
| | | | of the quaternion. |
| z | number | 1 . . . 1 | Provides the z coordinate |
| | | | of the quaternion. |
| w | number | 1 . . . 1 | Provides the w coordinate |
| | | | of the quaternion. |
| position | Object | 0 . . . 1 | Represents the position of |
| | | | the pose relative to the XR |
| | | | space identified by xrSpaceId. |
| x | number | 1 . . . 1 | Provides the x coordinate |
| | | | of the position vector. |
| y | number | 1 . . . 1 | Provides the y coordinate |
| | | | of the position vector. |
| z | number | 1 . . . 1 | Provides the z coordinate |
| | | | of the position vector. |
| confidence | number | 0 . . . 1 | Provides a confidence score |
| | | | that reflects the probability |
| | | | for this pose prediction to |
| | | | be correct. For the current |
| | | | pose or a pose in the past, |
| | | | the confidence value would be |
| | | | 1. The confidence can take a |
| | | | value between 0 and 1, where 0 |
| | | | means a 0% confidence and 1 |
| | | | means a 100% confidence. |
| estimatedAtTime | number | 0 . . . 1 | The wall clock time when |
| | | | the pose estimation |
| | | | was made. (ref. T1) |
| fov | Object | 0 . . . 1 | Indicates the four sides of |
| | | | the field of view used |
| | | | for the projection of the |
| | | | corresponding XR view. |
| | | | This field is present if these |
| | | | field of view values have |
| | | | changed from the last sent |
| | | | values. |
| | | | This is applicable for view |
| | | | poses |
| angleLeft | number | 1 . . . 1 | The angle in radians of the |
| | | | left side of the field of view. |
| | | | For a symmetric field of |
| | | | view this value is negative. |
| angleRight | number | 1 . . . 1 | The angle in radians of the |
| | | | right side of the field of view. |
| angleUp | number | 1 . . . 1 | The angle in radians of the top |
| | | | part of the field of view. |
| angleDown | number | 1 . . . 1 | The angle in radians of the |
| | | | bottom part of the field of view. |
| | | | For a symmetric field |
| | | | of view this value is negative. |

A client may transmit an indication of a gaze of a user on a display panel of a device using the pose format indicated in Table 1 above.

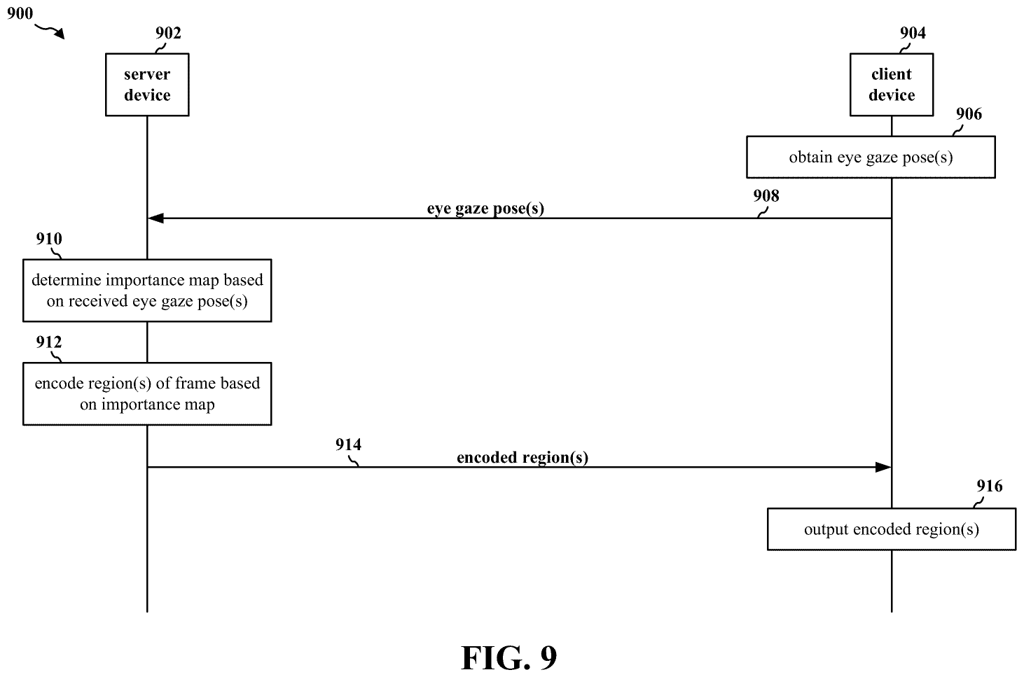

FIG. 9 is a connection flow diagram 900 illustrating an example of a server device 902 configured to communicate with a client device 904. The client device 904 may include a wearable display device, a headset, or an HMD. The server device 902 and the client device 904 may be used to provide a split rendering for XR content. The client device 904 and the server device 902 may each be a wireless communications device having a transceiver or an antenna used to transmit communication signals between the server device 902 and the client device 904.

At 906, the client device 904 may obtain a set of eye gaze poses for a user of the client device 904. The set of eye gaze poses may include eye gaze poses of each eye of the user with respect to a display, or a portion of a display, that the eye of the user is focused on. The client device 904 may associate each of the set of eye gaze poses with a time interval. In some aspects, at least a subset of the set of eye gaze poses may be associated with future time intervals (i.e., predicted eye gaze poses). The future time intervals may be time intervals for which the set of predicted eye gaze poses is valid. The client device 904 may associate a confidence interval with each of the set of eye gaze poses. The confidence interval may indicate a level of confidence in the prediction of the associated eye gaze pose. In some aspects, the client device 904 may generate, via a camera of the client device 904, a set of predicted eye gaze poses based on historical eye gaze poses of the user captured by the camera. For example, where the historical eye gaze poses of the user are focused on an object displayed by the client device 904, the predicted eye gaze poses may be associated with locations of where the object displayed by the client device 904 will be in the future. In some aspects, an XR runtime of the client device 904 may determine the set of confidence values for the set of predicted eye gaze poses (e.g., an OpenXR function xrGetEyeGazesFB may return a confidence value). In another aspect, the client device 904 may estimate a confidence value based on confidence criteria, for example at least one of a time delta between the current time and the time for which the prediction applies, a distance of the predicted eye gaze pose from the current eye gaze pose of the user, and/or an estimated velocity of the eye gaze moving (e.g., tracking a moving object) at the predicted time of the predicted eye gaze pose.

The client device 904 may transmit an indication of the set of eye gaze poses 908 obtained at 906 to the server device 902. The server device may receive the indication of the set of eye gaze poses 908 from the client device 904. The indication of the set of eye gaze poses 908 may indicate a set of predicted eye gaze poses, where each of the set of predicted eye gaze poses is associated with a score and/or a confidence interval. The indication of the set of eye gaze poses 908 may indicate a set of predicted eye gaze poses, where each of the set of predicted eye gaze poses is associated with a time for which the eye gaze prediction is estimated. An eye gaze pose prediction may indicate an orientation of an eye of the user of the client device 904. The indication may be transmitted using the format shown in FIG. 8 or Table 1. In other words, the indication of the set of eye gaze poses 908 may include at least one of a set of predicted eye gaze poses of a user of the client device 904, a set of time intervals for which the set of predicted eye gaze poses is valid, or a set of confidence values for the set of predicted eye gaze poses. In some aspects, the server device 902 and the client device 904 may be configured to perform a negotiation to enable eye tracking and transmission by the client device 904. In such aspects, the client device 904 may transmit the indication of the set of eye gaze poses 908 subsequent to the performed negotiation.

At 910, the server device 902 may determine, or calculate, an importance map based on the received indication of the set of eye gaze poses 908. For example, the server device 902 may determine the importance map as the frame 602 in FIG. 6 with an ROI 604 having a first size and an ROI 606 having a second size. The server device 902 may use the determined importance map for encoding of a frame. At 910, the server device 902 may normalize the set of confidence values based on the set of eye gaze poses 908. The server device 902 may compute the importance map based on the normalized set of confidence values. In some aspects, the server device 902 may sort the set of eye gaze poses 908 based on the normalized set of confidence values. For example, the server device 902 may sort gaze pose predictions by descending order for their normalized confidence values. The server device 902 may identify, based on the sorted set of eye gaze poses and the normalized set of confidence values, the set of regions of the frame, for example the ROI 604 and the ROI 606 in the frame 602 in FIG. 6. The server device 902 may assign, based on the normalized set of confidence values, a set of importance values to the set of regions, for example a size of the region, or an importance ranking for the region. For example, the server device 902 may determine the radius for each importance region, where higher confidence means a larger radius. In another example, the server device 902 may determine the importance value to be assigned to a region based on the magnitude of the normalized confidence. In some aspects, where the indication of the set of eye gaze poses 908 does not include any confidence values, the server device 902 may calculate/estimate a confidence value. For example, the server device 902 may determine a confidence value based on a time delta between the current time and the time for which the prediction applies. (e.g., the encoding at 912 may happen at the server device 902 about 20-50 milliseconds after eye gaze pose is determined at 906) In another example, the server device 902 may determine a confidence value based on a distance of a predicted eye gaze pose to the eye gaze pose at the current time. In another example, the server device 902 may determine a confidence value based on an estimated velocity of the eye gaze pose at the predicted eye gaze pose orientation. In some aspects, the server device 902 may merge regions. For example, the server device 902 may determine that a first region and a second region of the set of regions having a minimum metric (e.g., a minimum size, a minimum importance ranking) are within a threshold distance of one another, and may merge the regions into a single region based on the determination. The server device 902 may then assign, based on the metric (i.e., an importance value for each region) of each unmerged region a single confidence value to the single region. In other words, the server device 902 may merge importance regions that are too close.

In some aspects, the server device 902 may generate a 2D map that matches a CTU subdivision of the frame. The server device 902 may scale the importance values based on the fraction of the CTUs covered by an importance region to the total number of CTUs in the frame. In another aspect, the server device 902 may sum the areas of all importance regions to the area of the full frame. The server device 902 may then assign a minimum importance value to the remaining CTUs/areas of the full frame after assigning corresponding importance values to the designated regions based on the set of eye gaze poses 908. In other words, the server device 902 may identify a set of importance regions associated with the set of eye gaze poses 908 and a set of non-importance regions not associated with the set of eye gaze poses 908, assign a minimum importance value to the set of non-importance regions, and assign corresponding importance values associated with the set of eye gaze poses 908 based on the confidence value.

In some aspects, the indication of the set of eye gaze poses 908 may include at least one of an indication of prior eye gaze pose information for the user of the client device 904, an indication of animation elements associated with the frame to be rendered by the server device 902, interactivity elements associated with the frame to be rendered by the server device 902, or another ROI associated with the frame to be rendered by the server device 902. The server device 902 may determine the importance map based on the indication, for example by assigning a threshold importance value (e.g., a second minimum importance value greater than the absolute minimum importance value) to regions associated with interactivity elements that will be rendered in the frame.

At 912, the server device 902 may encode a set of regions for the frame based on the importance map determined at 910. For example, the server device 902 may encode a ROI having a first importance value with a higher bitrate or a higher resolution than a portion of the frame importance map having a second importance value, where the first importance value is higher than the second importance value. In other words, the server device 902 may adjust a bitrate for each region of the frame based on values assigned to the importance map determined at 910. Different regions of the frame may have different bitrates based on importance values of the importance map. The server device 902 may use ROI maps and foveation maps of the importance map to adapt the encoding of video frames.

The server device 902 may transmit an indication of the set of encoded regions 914 for a set of frames to the client device 904. The client device 904 may receive the indication of the set of encoded regions 914 for the set of frames from the server device 902. The server device 902 may transmit a bitstream to produce a frame as the indication of the set of encoded regions 914 for the set of frames. The bitstream may include the adjusted bitrate of the server device 902 encoded at 912.

At 916, the client device 904 may decode the bitstream to produce a set of frames. The bitstream may have different bitrates for different regions of the set of regions. The client device 904 may output the set of encoded regions, for example to a set of displays for the user, or to a reprojection engine for reprojection of the set of frames.

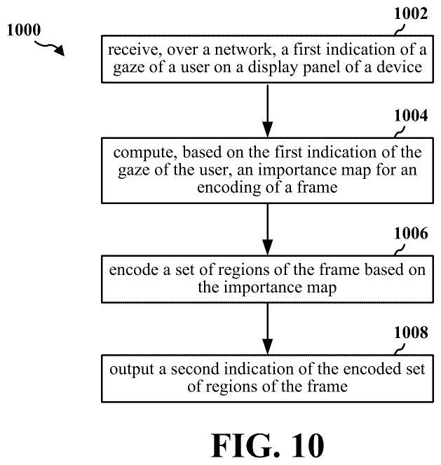

FIG. 10 is a flowchart 1000 of an example method of graphics processing in accordance with one or more techniques of this disclosure. The method may be performed by an apparatus, such as an apparatus for graphics processing, a GPU, a CPU, the device 104, a server, a remote device, a companion device, a wireless communication device, and the like, as used in connection with the aspects of FIGS. 1-9. The method may be associated with various advantages, such as reducing network traffic between a server and a wearable display device and/or reducing usage of computational resources of the server. In an example, the method (including the various aspects detailed below) may be performed by the foveated renderer 198.

At 1002, the apparatus (e.g., a server) receives, over a network, a first indication of a gaze of a user on a display panel of a device. In one example, 1002 may be performed by the server device 902 in FIG. 9, which may receive, over a network, the indication of a set of eye gaze poses 908 from the client device 904. The set of eye gaze poses 908 may include a gaze of a user on a display panel of the client device 904. In another example, 1002 may be performed by the foveated renderer 198.

At 1004, the apparatus (e.g., a server) computes, based on the first indication of the gaze of the user, an importance map for an encoding of a frame. In one example, 1004 may be performed by the server device 902 in FIG. 9, which may, at 910, compute, based on the indication of the set of eye gaze poses 908, an importance map for the encoding of a set of frames at 912. In another example, 1004 may be performed by the foveated renderer 198.

At 1006, the apparatus (e.g., a server) encodes a set of regions of the frame based on the importance map. In one example, 1006 may be performed by the server device 902 in FIG. 9, which may, at 912, encode a set of regions of the frame based on the importance map determined at 910. In another example, 1006 may be performed by the foveated renderer 198.

At 1008, the apparatus (e.g., a server) outputs a second indication of the encoded set of regions of the frame. In one example, 1008 may be performed by the server device 902 in FIG. 9, which may, at 916, transmit an indication of the set of encoded regions 914 to the client device 904. The set of encoded regions 914 may include an encoded set of regions of the frame. In another example, 1008 may be performed by the foveated renderer 198.

In one aspect, encoding the set of regions of the frame may include adjusting a bitrate for at least one region in the set of regions of the frame based on the importance map.

In one aspect, adjusting the bitrate for the at least one region in the set of regions may include setting a first bitrate for a first region in the at least one region and setting a second bitrate for a second region in the at least one region, where the first bitrate may be different from the second bitrate.

In one aspect, outputting the second indication of the encoded set of regions of the frame may include transmitting, for the device, a bitstream that includes the adjusted bitrate for the at least one region in the set of regions of the frame.

In one aspect, the first indication of the gaze of the user may include at least one of a set of predicted eye gaze poses of the user, a set of time intervals for which the set of predicted eye gaze poses is valid, or a set of confidence values for the set of predicted eye gaze poses.

In one aspect, computing the importance map may further include: normalizing the set of confidence values based on the set of predicted eye gaze poses, where computing the importance map includes computing the importance map further based on the normalized set of confidence values.

In one aspect, computing the importance map may further include: sorting the set of predicted eye gaze poses based on the normalized set of confidence values.

In one aspect, computing the importance map may further include: identifying, based on (1) the sorted set of predicted eye gaze poses and (2) the normalized set of confidence values, the set of regions of the frame.

In one aspect, computing the importance map may further include: assigning, based on the normalized set of confidence values, a set of importance values to the set of regions of the frame.

In one aspect, computing the importance map may further include: determining that a first region and a second region in the set of regions are within a threshold distance of one another.

In one aspect, computing the importance map may further include: merging, based on the determination, the first region and the second region into a single region.

In one aspect, computing the importance map may further include: assigning, based on a first importance value of the first region and a second importance value of the second region, a single confidence value to the single region.

In one aspect, each of the set of regions may be associated with one or more coding tree units (CTUs).

In one aspect, identifying the set of regions of the frame may include identifying a set of importance regions and a set of non-importance regions, and where assigning the set of importance values may include assigning a minimum importance value to each of the set of non-importance regions.

In one aspect, the apparatus (e.g., a server) may obtain a third indication including at least one of prior gaze information for the user of the device, animation elements associated with the frame, interactivity elements associated with the frame, or region of interest (ROI) information associated with the frame, where computing the importance map may include computing the importance map further based on the third indication.

In one aspect, the frame may be associated with extended reality (XR) content of the device, and where the device may be one of a wearable display device, a headset, or a head-mounted display (HMD).

In one aspect, receiving the first indication of the gaze of the user may include receiving, via a wireless connection, the first indication of the gaze.

In one aspect, the apparatus (e.g., a server) may perform a negotiation with the device to enable eye tracking and transmission, where receiving the first indication of the gaze may include receiving the first indication of the gaze subsequent to the performed negotiation.

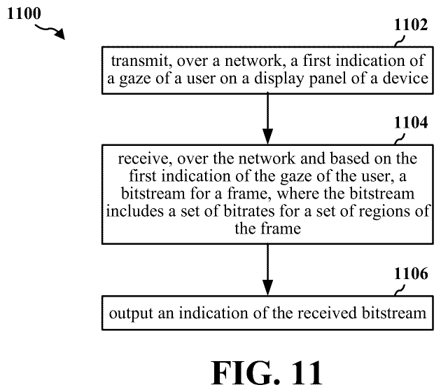

FIG. 11 is a flowchart 1100 of an example method of graphics processing in accordance with one or more techniques of this disclosure. The method may be performed by an apparatus, such as an apparatus for graphics processing, a GPU, a CPU, the device 104, a wearable display device, an HMD, XR glasses, a wireless communication device, and the like, as used in connection with the aspects of FIGS. 1-9. The method may be associated with various advantages, such as reducing network traffic between a server and a wearable display device and/or reducing usage of computational resources of the server. In an example, the method (including the various aspects detailed below) may be performed by the foveated renderer 199.

At 1102, the apparatus (e.g., a wearable display device) transmits, over a network, a first indication of a gaze of a user on a display panel of a device. For example, 1102 may be performed by the client device 904 in FIG. 9, which may transmit, over a network, an indication of a set of eye gaze poses 908 to the server device 902. The set of eye gaze poses 908 may include a gaze of a user on a display panel of the client device 904. In another example, 1102 may be performed by the foveated renderer 199.

At 1104, the apparatus (e.g., a wearable display device) receives, over the network and based on the first indication of the gaze of the user, a bitstream for a frame, where the bitstream includes a set of bitrates for a set of regions of the frame. For example, 1102 may be performed by the client device 904 in FIG. 9, which may receive, over the network and based on the indication of the set of eye gaze poses 908, a bitstream for a frame as the indication of the set of encoded regions 914. The bitstream may include a set of bitrates for a set of regions of the frame. In another example, 1104 may be performed by the foveated renderer 199.

At 1106, the apparatus (e.g., a wearable display device) outputs an indication of the received bitstream. For example, 1102 may be performed by the client device 904 in FIG. 9, which may, at 916, output an indication of the received bitstream as the set of encoded regions. In another example, 1106 may be performed by the foveated renderer 199.

In one aspect, the apparatus (e.g., a wearable display device) may perform a negotiation with a server to enable eye tracking and transmission, where transmitting the first indication of the gaze may include transmitting the first indication of the gaze subsequent to the performed negotiation.

In one aspect, the bitstream may include a first bitrate for a first region in the set of regions and a second bitrate for a second region in the set of regions, where the first bitrate may be different from the second bitrate.

In one aspect, the first indication of the gaze of the user may include at least one of a set of predicted eye gaze poses of the user, a set of time intervals for which the set of predicted eye gaze poses is valid, or a set of confidence values for the set of predicted eye gaze poses.

In one aspect, the apparatus (e.g., a wearable display device) may generate, via a camera of the device, the set of predicted eye gaze poses of the user.

In one aspect, the apparatus (e.g., a wearable display device) may obtain, via an extended reality (XR) runtime, the set of confidence values for the set of predicted eye gaze poses.

In one aspect, the apparatus (e.g., a wearable display device) may estimate, based on confidence criteria, the set of confidence values for the set of predicted eye gaze poses.

In one aspect, the confidence criteria may include at least one of a time difference between a first time instance corresponding to a transmission of the first indication and a second time instance corresponding to a display time for the frame, a set of head poses of the user, or an estimated velocity of a head of the user.

In one aspect, the bitstream may be encoded, where outputting the indication of the received bitstream may include: decoding the bitstream to produce the frame.

In one aspect, the bitstream may be encoded, where outputting the indication of the received bitstream may further include: transmitting the frame for display on the display panel.

In one aspect, transmitting the first indication of the gaze of the user may include transmitting, via a wireless connection, the first indication of the gaze.

In one aspect, the frame may be associated with extended reality (XR) content of the device, and where the device may be one of a wearable display device, a headset, or a head-mounted display (HMD).

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for receiving, over a network, a first indication of a gaze of a user. The indication may indicate where, on a display panel of a device, the user is gazing. The apparatus may further include means computing, based on the first indication of the gaze of the user, an importance map for an encoding of a frame. The apparatus may further include means for encoding a set of regions of the frame based on the importance map. The apparatus may further include means for outputting a second indication of the encoded set of regions of the frame. The apparatus may further include means for obtaining a third indication including at least one of prior gaze information for the user of the device, animation elements associated with the frame, interactivity elements associated with the frame, or region of interest (ROI) information associated with the frame, where computing the importance map includes computing the importance map further based on the third indication. The apparatus may further include means for performing a negotiation with the device to enable eye tracking and transmission, where receiving the first indication of the gaze includes receiving the first indication of the gaze subsequent to the performed negotiation.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for transmitting, over a network, a first indication of a gaze of a user on a display panel of a device. The apparatus may further include means for receiving, over the network and based on the first indication of the gaze of the user, a bitstream for a frame, where the bitstream includes a set of bitrates for a set of regions of the frame. The apparatus may further include means for outputting an indication of the received bitstream. The apparatus may further include means for performing a negotiation with a server to enable eye tracking and transmission, where transmitting the first indication of the gaze includes transmitting the first indication of the gaze subsequent to the performed negotiation. The apparatus may further include means for generating, via a camera of the device, the set of predicted eye gaze poses of the user. The apparatus may further include means for obtaining, via an extended reality (XR) runtime, the set of confidence values for the set of predicted eye gaze poses. The apparatus may further include means for estimating, based on confidence criteria, the set of confidence values for the set of predicted eye gaze poses.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: receiving, over a network, a first indication of a gaze of a user; computing, based on the first indication of the gaze of the user, an importance map for an encoding of a frame; encoding a set of regions of the frame based on the importance map; and outputting a second indication of the encoded set of regions of the frame. The indication of the gaze may indicate where, on a display panel of the device, the user is gazing.

Aspect 2 is the method of aspect 1, wherein encoding the set of regions of the frame comprises adjusting a bitrate for at least one region in the set of regions of the frame based on the importance map.

Aspect 3 is the method of aspect 2, wherein adjusting the bitrate for the at least one region in the set of regions comprises setting a first bitrate for a first region in the at least one region and setting a second bitrate for a second region in the at least one region, wherein the first bitrate is different from the second bitrate.

Aspect 4 is the method of either of aspects 2 or 3, wherein outputting the second indication of the encoded set of regions of the frame comprises transmitting a bitstream that includes the adjusted bitrate for the at least one region in the set of regions of the frame. The transmission may be for a client device of a split XR system.

Aspect 5 is the method of any of aspects 1 to 4, wherein the first indication of the gaze of the user comprises at least one of a set of predicted eye gaze poses of the user, a set of time intervals for which the set of predicted eye gaze poses is valid, or a set of confidence values for the set of predicted eye gaze poses.

Aspect 6 is the method of aspect 5, wherein computing the importance map further comprises: normalizing the set of confidence values based on the set of predicted eye gaze poses; and computing the importance map further based on the normalized set of confidence values.

Aspect 7 is the method of aspect 6, wherein computing the importance map further comprises: sorting the set of predicted eye gaze poses based on the normalized set of confidence values.

Aspect 8 is the method of aspect 7, wherein computing the importance map further comprises: identifying, based on (1) the sorted set of predicted eye gaze poses and (2) the normalized set of confidence values, the set of regions of the frame; and assigning, based on the normalized set of confidence values, a set of importance values to the set of regions of the frame.

Aspect 9 is the method of aspect 8, wherein computing the importance map further comprises: determining that a first region and a second region in the set of regions are within a threshold distance of one another; merging, based on the determination, the first region and the second region into a single region; and assigning, based on a first importance value of the first region and a second importance value of the second region, a single confidence value to the single region.

Aspect 10 is the method of either of aspects 8 or 9, wherein each of the set of regions is associated with one or more coding tree units (CTUs).

Aspect 11 is the method of aspect 10, wherein identifying the set of regions of the frame comprises identifying a set of importance regions and a set of non-importance regions, and wherein assigning the set of importance values comprises assigning a minimum importance value to each of the set of non-importance regions.

Aspect 12 is the method of any of aspects 1 to 11, further comprising: obtaining a third indication comprising at least one of prior gaze information for the user, animation elements associated with the frame, interactivity elements associated with the frame, or region of interest (ROI) information associated with the frame, wherein computing the importance map comprises computing the importance map further based on the third indication. The user may be a user of a client device of a split XR system.

Aspect 13 is the method of any of aspects 1 to 12, wherein the frame is associated with extended reality (XR) content of a device, and wherein the device is one of a wearable display device, a headset, or a head-mounted display (HMD).

Aspect 14 is the method of any of aspects 1 to 13, wherein receiving the first indication of the gaze of the user comprises receiving, via a wireless connection, the first indication of the gaze.

Aspect 15 is the method of any of aspects 1 to 14, further comprising: performing a negotiation with the device to enable eye tracking and transmission, wherein receiving the first indication of the gaze comprises receiving the first indication of the gaze subsequent to the performed negotiation.

Aspect 16 is a method of graphics processing, comprising: transmitting, over a network, a first indication of a gaze of a user on a display panel of a device; receiving, over the network and based on the first indication of the gaze of the user, a bitstream for a frame, wherein the bitstream includes a set of bitrates for a set of regions of the frame; and outputting an indication of the received bitstream.

Aspect 17 is the method of aspect 16, further comprising: performing a negotiation with a server to enable eye tracking and transmission, wherein transmitting the first indication of the gaze comprises transmitting the first indication of the gaze subsequent to the performed negotiation.

Aspect 18 is the method of either of aspects 16 or 17, wherein the bitstream includes a first bitrate for a first region in the set of regions and a second bitrate for a second region in the set of regions, wherein the first bitrate is different from the second bitrate.

Aspect 19 is the method of any of aspects 16 to 18, wherein the first indication of the gaze of the user comprises at least one of a set of predicted eye gaze poses of the user, a set of time intervals for which the set of predicted eye gaze poses is valid, or a set of confidence values for the set of predicted eye gaze poses.

Aspect 20 is the method of aspect 19, further comprising: generating, via a camera of the device, the set of predicted eye gaze poses of the user.

Aspect 21 is the method of aspect 19, further comprising: obtaining, via an extended reality (XR) runtime, the set of confidence values for the set of predicted eye gaze poses.

Aspect 22 is the method of either of aspect 19 or 20, further comprising: estimating, based on confidence criteria, the set of confidence values for the set of predicted eye gaze poses.

Aspect 23 is the method of aspect 22, wherein the confidence criteria comprise at least one of a time difference between a first time instance corresponding to a transmission of the first indication and a second time instance corresponding to a display time for the frame, a set of head poses of the user, or an estimated velocity of a head of the user.

Aspect 24 is the method of any of aspects 16 to 23, wherein the bitstream is encoded, wherein outputting the indication of the received bitstream comprises: decoding the bitstream to produce the frame; and transmitting the frame for display on the display panel.

Aspect 25 is the method of any of aspects 16 to 24, wherein transmitting the first indication of the gaze of the user comprises transmitting, via a wireless connection, the first indication of the gaze.

Aspect 26 is the method of any of aspects 16 to 25, wherein the frame is associated with extended reality (XR) content of the device, and wherein the device is one of a wearable display device, a headset, or a head-mounted display (HMD).

Aspect 27 is an apparatus for graphics processing including at least one processor coupled to a memory and configured to implement a method as in any of aspects 1-26.

Aspect 28 is an apparatus for graphics processing including means for implementing a method as in any of aspects 1-26.

Aspect 29 is a computer-readable medium storing computer executable code, the code when executed by at least one processor causes the at least one processor to implement a method as in any of aspects 1-26.

Aspect 30 may be combined with aspect 27 and includes that the apparatus is a wireless communication device.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
receive, over a network, a first indication of a gaze of a user;
compute, based on the first indication of the gaze of the user, an importance map for an encoding of a frame;
encode a set of regions of the frame based on the computed importance map; and
output a second indication of the encoded set of regions of the frame.

2. The apparatus of claim 1, wherein, to encode the set of regions of the frame, the processor is further configured to:
adjust a bitrate for at least one region in the set of regions of the frame based on the importance map.

3. The apparatus of claim 2, wherein, to adjust the bitrate for the at least one region in the set of regions, the processor is further configured to:
set a first bitrate for a first region in the at least one region and set a second bitrate for a second region in the at least one region, wherein the first bitrate is different from the second bitrate.

4. The apparatus of claim 2, wherein, to output the second indication of the encoded set of regions of the frame, the processor is further configured to:
transmit a bitstream that includes the adjusted bitrate for the at least one region in the set of regions of the frame.

5. The apparatus of claim 1, wherein the first indication of the gaze of the user comprises at least one of a set of predicted eye gaze poses of the user, a set of time intervals for which the set of predicted eye gaze poses is valid, or a set of confidence values for the set of predicted eye gaze poses.

6. The apparatus of claim 5, wherein, to compute the importance map, the processor is further configured to:
normalize the set of confidence values based on the set of predicted eye gaze poses; and
compute the importance map based on the normalized set of confidence values.

7. The apparatus of claim 6, wherein, to compute the importance map, the processor is further configured to:
sort the set of predicted eye gaze poses based on the normalized set of confidence values.

8. The apparatus of claim 7, wherein, to compute the importance map, the processor is further configured to:
identify, based on (1) the sorted set of predicted eye gaze poses and (2) the normalized set of confidence values, the set of regions of the frame; and
assign, based on the normalized set of confidence values, a set of importance values to the set of regions of the frame.

9. The apparatus of claim 8, wherein, to compute the importance map, the processor is further configured to:
determine that a first region and a second region in the set of regions are within a threshold distance of one another;
merge, based on the determination, the first region and the second region into a single region; and
assign, based on a first importance value of the first region and a second importance value of the second region, a single confidence value to the single region.

10. The apparatus of claim 8, wherein each of the set of regions is associated with one or more coding tree units (CTUs).

11. The apparatus of claim 10, wherein, to identify the set of regions of the frame, the processor is further configured to identify a set of importance regions and a set of non-importance regions, and wherein to assign the set of importance values, the processor is configured to assign a minimum importance value to each of the set of non-importance regions.

12. The apparatus of claim 1, wherein the processor is further configured to:
obtain a third indication comprising at least one of prior gaze information for the user, animation elements associated with the frame, interactivity elements associated with the frame, or region of interest (ROI) information associated with the frame, wherein to compute the importance map, the processor is configured to compute the importance map further based on the third indication.

13. The apparatus of claim 1, wherein the frame is associated with extended reality (XR) content of a device, and wherein the device comprises one of a wearable display device, a headset, or a head-mounted display (HMD).

14. The apparatus of claim 1, wherein the apparatus comprises a wireless communication device comprising at least one of a transceiver or an antenna coupled to the processor, wherein the processor is further configured to receive the first indication of the gaze of the user via at least one of the transceiver or the antenna.

15. The apparatus of claim 1, wherein the processor is further configured to:
perform a negotiation with a device to enable eye tracking and transmission, wherein to receive the first indication of the gaze, the processor is configured to receive the first indication of the gaze subsequent to the performed negotiation.

16. An apparatus for graphics processing, comprising:
a memory; and
a processor coupled to the memory and, based on information stored in the memory, the processor is configured to:
transmit, over a network, a first indication of a gaze of a user on a display panel of a device;
receive, over the network and based on the first indication of the gaze of the user, a bitstream for a frame, wherein the bitstream includes a set of bitrates for a set of regions of the frame; and
output an indication of the received bitstream.

17. The apparatus of claim 16, wherein the first indication of the gaze of the user comprises at least one of a set of predicted eye gaze poses of the user, a set of time intervals for which the set of predicted eye gaze poses is valid, or a set of confidence values for the set of predicted eye gaze poses, wherein the processor is further configured to:
generate, via a camera of the device, the set of predicted eye gaze poses of the user;
obtain, via an extended reality (XR) runtime, the set of confidence values for the set of predicted eye gaze poses; or
estimate, based on confidence criteria, the set of confidence values for the set of predicted eye gaze poses.

18. The apparatus of claim 17, wherein the confidence criteria comprise at least one of a time difference between a first time instance corresponding to a transmission of the first indication and a second time instance corresponding to a display time for the frame, a set of head poses of the user, or an estimated velocity of a head of the user.

19. The apparatus of claim 16, wherein the bitstream is encoded, wherein to output the indication of the received bitstream, the processor is configured to:
decode the bitstream to produce the frame; and
transmit the frame for display on the display panel.

20. A method of graphics processing, comprising:
receiving, over a network, a first indication of a gaze of a user on a display panel of a device;
computing, based on the first indication of the gaze of the user, an importance map for an encoding of a frame;
encoding a set of regions of the frame based on the importance map; and
outputting a second indication of the encoded set of regions of the frame.
